(19) United States
(12) Patent Application Publication
(10) Pub. No.: US 2015/0379528 A1
(43) Pub. Date: Dec. 31, 2015

(54) SOCIAL NETWORK USAGE-BASED SALES INSIGHTS

(71) Applicant: LinkedIn Corporation, Mountain View, CA (US)

(72) Inventors: Abhishek Gupta, San Francisco, CA (US); Anmol Bhasin, Los Altos, CA (US); Tingting Cui, Mountain View, CA (US); Zang Li, Milpitas, CA (US); Bo Hu, Mountain View, CA (US); Enhua Tan, San Jose, CA (US); Erem Huston Boto, San Mateo, CA (US); Hailin Wu, Palo Alto, CA (US); Annabel Fang Liu, Los Altos, CA (US); Qi Liu, Saratoga, CA (US); Angela Yoonjeong Yang, San Francisco, CA (US); Sachin Rekhi, Mountain View, CA (US)

(21) Appl. No.: 14/482,971

(22) Filed: Sep. 10, 2014

Related U.S. Application Data
(60) Provisional application No. 62/019,370, filed on Jun. 30, 2014.

(51) Int. Cl. G06Q 30/02; G06Q 50/00

(52) U.S. Cl. CPC G06Q 30/0201; G06Q 50/01

(57) ABSTRACT

In an example embodiment, information about one or more Customer Relationship Management (CRM) entities is received from a CRM system, the information including an identification of each of the one or more CRM entities and usage information about how a user interacted with each of the one or more CRM entities. Then, at a software tool distinct from the CRM system, one or more actionable insights related to the one or more CRM entities are identified. The relevance of the one or more actionable insights to the user is then determined based on the usage information. One or more of the one or more actionable insights are then presented to the user based on the determined relevance via the software tool.

### RELATED APPLICATIONS

This application claims priority to U.S. Provisional Application No. 62/019,370, entitled “CRM-BASED SALES STREAM INSIGHTS”, filed Jun. 30, 2014, which is incorporated by reference herein in its entirety.

### TECHNICAL FIELD

This application relates to the technical fields of computer software and, in one example embodiment, to presentation of sales insights based on social network usage information.

### BACKGROUND

Customer relationship management (CRM) is a system used to manage an entity's interactions with current and future customers. It often involves utilizing technology to organize, automate, and synchronize sales, marketing, customer service, and/or technical support. The general goal of CRM systems is to enable entities to better manage their customers through the introduction of reliable systems, processes, and procedures for interacting with those customers. CRM systems are also used to manage business contacts, clients, contract wins, sales leads, etc.

From the salesperson perspective, there are number of different tools providing sales intelligence that are available to salespeople. There is a need, however, for a system that could provide sales insights based on CRM information.

### BRIEF DESCRIPTION OF DRAWINGS

Embodiments are illustrated by way of example and not limitation in the figures of the accompanying drawings, in which like reference numbers indicate similar elements and in which:

FIG. 1 is a block diagram illustrating a system for CRM-based sales stream insights in accordance with an example embodiment.

FIG. 2 is a block diagram illustrating the insight module of FIG. 1 in more detail in accordance with an example embodiment.

FIG. 3 is a flow diagram illustrating a method of presenting actionable insights to a user in accordance with an example embodiment.

FIG. 4 is a screen capture illustrating an insight feed in accordance with an example embodiment.

FIG. 5 is a screen capture illustrating an insight feed in accordance with another example embodiment.

FIG. 6 is a screen capture illustrating an insight feed in accordance with another example embodiment.

FIG. 7 is a screen capture illustrating an insight feed accordance with another example embodiment.

FIG. 8 is a block diagram illustrating a mobile device according to an example embodiment.

FIG. 9 is a block diagram of machine in the example form of a computer system within which instructions, for causing the machine to perform any one or more of the methodologies discussed herein, can be executed.

### DETAILED DESCRIPTION

### Overview

The present disclosure describes, among other things, methods, systems, and computer program products, which individually provide functionality for surfacing content items to users of a content publishing system using impression discounting. In the following description, for purposes of explanation, numerous specific details are set forth in order to provide a thorough understanding of the various aspects of different embodiments of the present inventive subject matter. It will be evident, however, to one skilled in the art, that the present inventive subject matter may be practiced without all of the specific details.

In an example embodiment, a sales tool is provided that provides an account-centric view optimized for ideal sales workflows. Prospecting for new leads and accounts is simplified based on look-alike modelling, and sales professionals can be proactively notified of actionable insights on target accounts and leads.

In an example embodiment, the sales tool (and/or other sales tools) may be augmented by providing a mechanism to automatically import usage data from a CRM system and use this data for sales analysis and recommendations. For example, usage information about accounts and contacts for a salesperson (e.g., information about how the salesperson interacted with the accounts and contacts via the CRM system) can be automatically imported from the CRM system and applied in the sales tool to provide for actionable insights.

As used herein, the term “or” may be construed in either an inclusive or exclusive sense. Similarly, the term “exemplary” merely means an example of something or an exemplar and not necessarily a preferred or ideal means of accomplishing a goal. For the purposes of this description, the phrase “an on-line social networking application” may be referred to as and used interchangeably with the phrase “an on-line social network” or merely “a social network.” It will also be noted that an on-line social network may be any type of an on-line social network such as, for example, a professional network, an interest-based network, or any on-line networking system that permits users to join as registered members. For the purposes of this description, registered members of an on-line social network may be referred to as simply members.

It should be noted that the terms “contacts” and “leads” both are intended to refer to individuals. In the CRM environment it is typical to refer to such individuals as contacts and the information pertaining to those individuals stored in the CRM system as contact information. In the sales tool as described in this disclosure, it is common to refer to such individuals as leads, and the information pertaining to those individuals stored in the sales tool as lead information. Thus, in order to maintain this nomenclature, the present disclosure will refer to individuals as contacts with respect to the CRM systems and leads with respect to the sale tool for any other tool or non-CRM environment, such as in the social network service). For example, if information about an individual is imported from a CRM system to the sales tool, then the present disclosure may refer to it as importing a contact from the CRM system and saving it as a lead in the sales tool. Nevertheless, this is merely a nomenclature to remain consistent with usage in the field, and such terms shall be construed as interchangeable.

The process of important accounts and contacts from a CRM system to the sales tool or other tool and getting a user set up in that tool is known as “onboarding”. In an example embodiment, this onboarding may be performed in a tool that is integrated with an on-line social network to further leverage information across domains. Additionally, once the user is onboarded, the sales tool may be used in conjunction with the online social network. Thus, usage information from the social network may also be gathered and utilized by the sales tool in providing insights. In this way, the sales tool can provide sales insights based on both CRM usage information and social network usage information. For example, the fact that a salesperson interacted with a particular company's entry in a CRM system twenty times may be used to suggest insights related to that particular company in the sales tool. However, even if the salesperson interacted with that particular company's entry in the CRM system one time, if the salesperson interacted with the particular company's social network profile twenty times the sales tool may use this information to provide sales insights.

Each member of an on-line social network is represented by a member profile (also referred to as a profile of a member or simply a profile). A member profile may be associated with social links that indicate that member's connection to other members of the social network. A member profile may also include or be associated with comments or endorsements from other members of the on-line social network, with links to other network resources such as, for example, publications, etc. As mentioned above, an on-line social networking system may be designed to allow registered members to establish and document networks of people they know and trust professionally. Any two members of a social network may indicate their mutual willingness to be “connected” in the context of the social network, in that they can view each other's profiles, profile recommendations and endorsements for each other and otherwise be in touch via the social network. Reputation scores may be computed based on information obtained from trusted sources, such as patent databases, publications databases, skills, endorsement of skills, or even enterprise contracts.

In addition to member profiles, there may be a number of different types of data stored by the social network site. Additionally, data from other data sources, such as audio and video content, email and business documents, calendars, text messages, etc. may also be accessed by the social network site. It would be helpful if all this data could be accessed in an efficient manner and that whatever features the social network site is attempting to set up to access new data types or new data sources can be set up in an efficient manner.

Notably the members of the social network need not notably be individuals but can be businesses as well. For example, a company itself may be a member of the social network site and have a company profile page in the social network site, while employees of the company may each individually be members and have their own member pages, perhaps linked to the company profile page.

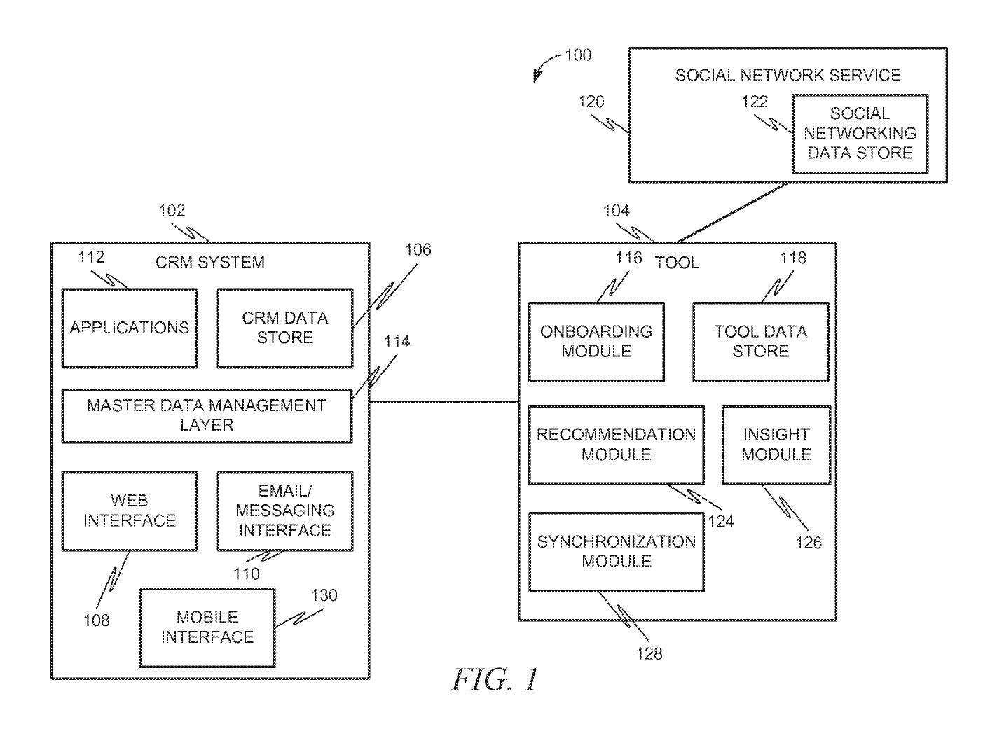

FIG. 1 is a block diagram illustrating a system 100 for CRM-based discovery of accounts and contacts. The system 100 may include a CRM system 102 and a tool 104. The tool 104 may be, for example, a sales tool that provides various sales insights. The CRM system 102 may include a CRM data store 106 that stores information about accounts and contacts for various users. In an example embodiment, the CRM system 102 may be offered as a Software as a Service (SaaS) component and thus the system 100 may be stored on a server or distributed among multiple servers. However, in some example embodiments the CRM system 102 and/or the CRM data store 106 may be located on a non-server computer such as a desktop computer, laptop computer, or mobile device. The CRM system 102 may include a web interface 108 to allow users to interact with the CRM system 102 via a web browser. The CRM system 102 may also include an email/messaging interface 110 that may interface with various other programs such as email or messaging clients to exchange information related to CRM tasks. The CRM system 102 can also include one or more marketing applications 112. A master data management layer 114 can be used to manage in all of the components in the CRM system 102.

The tool 104 may include an onboarding module 116 that is used to set up new users. As with the CRM system 102, the tool 104 may be implemented as a SaaS component on a server or distributed among multiple servers, although embodiments are possible where the tool 104 is located on a non-server computer. The data can be stored in tool data store 118.

Also contained in the system 100 is a social network service 120. The social network service 120 may contain various social networking profiles and links between the profiles, stored in a social networking data store 122. As with the CRM system 102, the social network service 120 may be implemented as a SaaS component on a server or distributed among multiple servers.

In an example embodiment, a recommendation module 124 can also be provided in the tool 104. The recommendation module 124 can recommend further accounts and/or leads from the social network service 120 based on a variety of factors.

In an example embodiment, an insight module 126 can also be provided in the tool 104. The insight module 126 can act to provide insights about the accounts and/or leads associated with a user. This may include mining data in the social network service 120 as well as information from the Internet in general (e.g., news searches, web page searches, etc.) to provide information about the accounts and/or leads that might be valuable to the user. For example, the user may be presented with recent news articles about an account, or a personal web page of a lead. This can enable the user to have, for example, information useful in breaking the ice or otherwise conversing with the account and/or lead, whether remotely (e.g., by email or phone) or in person (e.g., at a party).

In an example embodiment, a synchronization module 128 can also be provided in the tool 104. The synchronization module 128 can synchronize data between the tool data store 118 and the CRM data store 106, and can also be used to integrate the CRM information into the tool 104. The synchronization module 128 can utilize the profile and link information stored in the social networking data store 122 to aid in the onboarding process. This will be described in more detail below.

There may, of course, be other modules contained within the tool 104 that are not described here to provide additional functionality to the user.

Additionally, in some example embodiments the CRM system 102 may also contain a mobile interface 130, used to interface with one or more mobile devices.

In an example embodiment, accounts and/or contacts are retrieved from a CRM system. Accounts include account-level information about entities such as companies or other organizations. Contacts include contact-level information about individuals. The system can then attempt to map each account to a social network profile for a company or organization and map each contact to a social network profile for an individual. Additionally, usage information from the CRM system can be obtained at this point. The system is then able to generate within the tool insights based on this usage information.

Most CRM systems have both accounts and contacts. Accounts and contacts may generally be referred to as CRM entities.

There may be various types of CRM usage information that can be utilized to provide sales insights. Tracking how often and in what ways a user views a CRM entity in the CRM system can be useful in gauging the user interest in the CRM entity. This tracking can be analyzed based on absolute values, such as the total number of times the user has viewed the CRM entity, or relative values, such as how many times the user has viewed the CRM entity today, or what percentage of the user's total views were of this particular CRM entity, etc. Another example of CRM usage information is communication activity that occurs through the CRM system. Most CRM systems provide some type of internal communication, such as email. Thus, the system could track how many times, how often, etc. the user has communicated with the CRM entity. Another example of CRM usage information is modifications made to the CRM entities. The system could track, for example, when a user enters notes for the CRM entity (as often happens when making a phone call to the account or lead associated with the CRM entity), or changes data in the CRM entity (such as updating the phone number associated with the CRM entity). Essentially any interaction with the CRM entity or any other user interaction that pertains to the CRM entity may be useful in determining whether to potentially provide a sales insight to the user for that CRM entity.

As with the CRM usage information, there may also be various types of social network usage information that can be utilized to provide sales insights. Typically such usage revolves around profiles. For example, the system can track how often and in what manner a user visited a profile of an account or lead, as well as what actions were taken by the user with respect to the profile. The tracking can be analyzed based on absolute values or relative values, and can be directly tied to the profiles (such as visits to a profile or notes entered for a profile) or indirectly (such as communications made to or from entities corresponding to the profiles).

In an example embodiment, the system may take into account both CRM usage information and social network usage information to determine how interested a user is in a particular account or contact/lead. In some example embodiments, a rating or ranking may be applied to each entity based on this determination. For example, the system may assign a rating between 1 and 100 to each entity associated with a particular user; the higher the rating the higher the interest the user has in the entity (based on usage information). In some example embodiments, information other than usage information may be utilized to adjust the score. For example, the user's own profile could be examined to determine certain features of the user him or herself, and the system could then make certain assumptions about user interest in particular entities based on this information. As a specific example, the user may be anew, relatively junior sales associate, and thus it may be assumed that the user has a high interest in just about any contact (due to perhaps a desperation to get new clients in order to prove him or herself). In such an instance, perhaps the ratings of the entities associated with the user (e.g., the contacts imported from the CRM system) may be skewed higher than an older, seasoned sales associate with high profile clients, who may not be interested in chasing down every contact be or she meets. This analysis may even go deeper, looking at the user's interests and trying to determine how they may match up with contact interests. In another example embodiment, various information about each contact may be utilized to weight or otherwise alter the rating based on various assumptions. For example, if the contact is a very junior associate who is not in charge of account, the fact that the user has viewed the profile of that contact a number of times may not indicate much of a interest in the contact for business purposes but rather may suggest that the user has an interest in the contact for personal reasons (e.g., perhaps they are a friend). Such information may be integrated into the analysis of whether the user has interest in sales insights of the contact.

Once the user interest in each entity is determined, the system can then utilize this information to determine which particular insights to surface to the user. There are many different types of insights that can be surfaced, but generally an insight is an action taken by the entity or otherwise related to an entity. One example may be the mention of the entity in a news article or other published document. Another example may be a change in a profile of the entity (e.g., a lead updates his or her profile to indicate a job change). Another example may be important upcoming dates related to the entity, such as a work anniversary. Another example may be a new connection made by the entity, such as the entity connecting to a mutual friend on the social network. Thus, generally the insights may be information coming from either inside the social network (such as profile or relationship updates) or outside the social network (such as articles obtained from Internet sources).

The following represents a list of possible actionable insights that can be surfaced by the insight module 126 in an example embodiment. These are only intended to be examples and this list shall not be construed as being exhaustive.

1. Job changes of a saved lead
If a saved lead changes a position, the user can reach out to congratulate the lead, or to sell into the new company that the lead moved to (for a job change that involved a switch to a different company) or to look for another potential lead at the company that the lead left.

2. Network degree changes of a saved lead
If someone from a user's first degree network makes connection with a saved lead (i.e., a saved lead becomes the user's second degree connection), the user can reach out to the first connection to request an introduction.

3. News mention of lead or account
If a saved lead or account is mentioned in a news article, the user can reach out to congratulate.

4. New position fills
If a position of interest, as identified by sales preferences and saved accounts, is recently filled by someone, the user can save them as a lead.

5. Calendar connection suggestions
If a meeting has been conducted with someone outside the first degree network, the user can add them as a connection.

6. Lead shares an article or other content
If a lead performs a sharing action, the user may wish to comment on the shared article or content.

7. Lead work anniversary
if a lead has a work anniversary or other important date, the user may wish to send congratulations.

8. Company status update
If a company updates some aspect of their profile or page, such as posting an article or changing content, the user may wish to reach out to corresponding leads.

In an example embodiment, the insights are displayed as a feed-like stream to the users. In one example embodiment, the stream presents the insights in reverse chronological order based on the timestamp of each insight. In another example embodiment, a relevance model is used to give a certain weight to a type of insight, such as having job changes with greater weight than calendar connection suggestions. Information about the insights themselves may also be utilized to determine which to surface (and how to surface them). Each insight may have a vector that includes actor, verb, and object. Additional features about each of these aspects may also be stored, such as a time stamp, the relevance of the actor (e.g., if the actor is a lead or suggested lead, a popularity score (e.g., how popular the insight is to other users, such as determined by Observing interactions with the insight, such as clicks, likes, comments, or shares), actor features, and object features. Additional information, such as a company associated with the actor, may also be utilized.

In an example embodiment, relevance is only one aspect utilized to measure which insights to surface and how to surface them. Specifically, diversity, as measured either by insight type or by insights themselves, may be desirable and thus a determination of whether to a surface a particular insight may be skewed based on whether such an insight would provide such diversity. For example, if the system has surfaced five straight status updates to a user, it may want to ensure that the next insight is not a status update as the user may lose interest in insights in general if the insight type is not diverse. In another example, if the system has surfaced five straight insights (of various types) that pertain to only one account, it may want to ensure that the next insight pertains to a different account, for the same reason.

In one example embodiment, insights may be surfaced based on recentness. For example, newer insights may be more likely to be surfaced than older ones, because a user is likely to have more interest in more recent events than older ones, even if the user has not previously been exposed to one of the older insights (e.g., the user has not logged in to the tool 104 in awhile).

In another example embodiment, the recentness of an insight is examined based on a scale that differs based on a feature of the user, such as how active the user is in the system. A user who is very active (as judged by, for example, how often they interact with the tool 104), may be more likely to want insights that are very recent, even if they aren't as relevant to the user, than a user who is not very active (and who consequently may be more interested in the top relevant insights without regard for how old they are).

The following is a list of possible factors influencing insight relevance. It should be noted that this list shall not be interpreted as being exhaustive.

1. Insight Recentness

2. Corresponding Account & Lead (e.g., VIP accounts have higher relevance)

3. Insight Type

4. Stream Type (e.g., Global Stream vs. Detailed Stream)

5. Insight liquidity

6. User visit frequency

7. Insight type engagement rate

8. Diversity

9. Impression Discounting

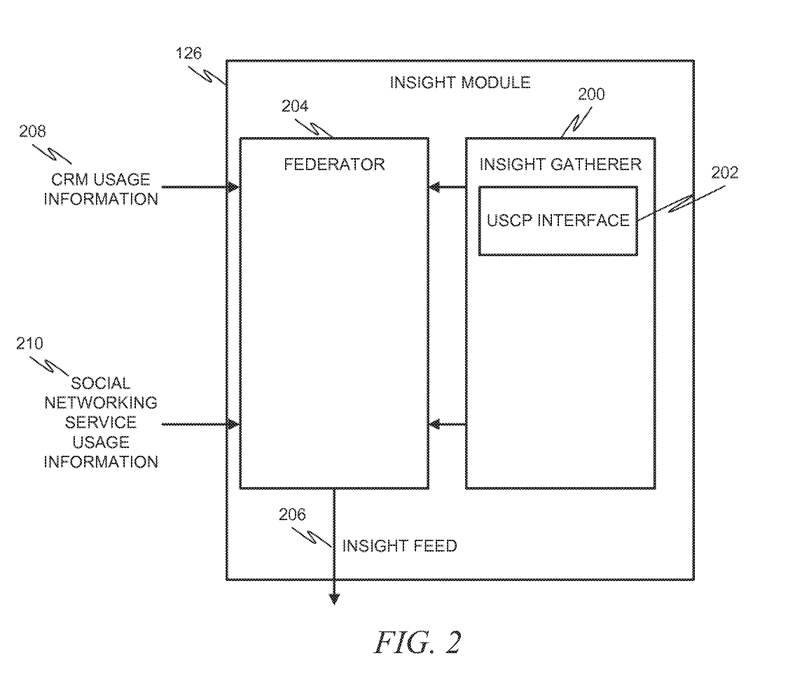

FIG. 2 is a block diagram illustrating the insight module 126 of FIG. 1 in more detail in accordance with an example embodiment. It should be noted that while the insight module 126 is depicted as receiving information from a CRM system (such as CRM system 102) and a social network service (such as social network service 120) this information may be received either directly or indirectly from these sources. If this information is received directly from these sources, a CRM interface and/or a social network interface may be contained in the insight module 126 to facilitate communication to one or more of these sources. If the information is received indirectly, a CRM interface and/or a social network interface may be contained in one or more other components in the tool 104, such as in the onboarding module 116 and the insight module 126 may receive the information from the CRM system 102 and social network service 120 via the tool data store 118, where it can be saved after the other components, such as the onboarding module 116, process the information from the outside sources.

Within the insight module 126, an insight gatherer 200 may gather one or more actionable insights. This may be accomplished in a number of different ways. In one example embodiment, the insight gatherer 200 looks at insights related to any lead or account in the tool 104, regardless of which user “owns” the lead or account. In another example embodiment, the insight gatherer 200 looks only for insights for leads or accounts owned by a particular user.

Insights can be gathered from a number of different sources. In one example embodiment (not pictured) the insight gatherer 200 may contain a number of interfaces to different potential sources of insights, such as interfaces to news organizations, social network services, etc. In another example embodiment, a Unified Social Content Platform (USCP) interface 202 is provided. USCP is a self-serve platform where all social activity may be published and retrieved. It is centered around the Actor/Verb/Object data model described earlier. Statements such as “Alfred connected to Bruce” and “Carole is following Bank of America” may be stored. A rich data model is built around this statement and includes a standard set of fields such as destination and visibility as well as application specific user defined fields.

Developers are able to register applications and their verbs and objects and select a template for rendering with the system through a self-serve API. The developers are then able to immediately begin publishing activity via a RESTful API using the added verbs and objects.

Thus, in this embodiment, the insight gatherer 200 may be somewhat passive, receiving streams of Actor/Verb/Object data structures from various sources via the USCP interface 202.

A federator 204 may then receive the insights from the insight gatherer 200 and blend one or more of the insights into an insight feed 206 based on relevance to the user. The relevance to the user may be determined based at least partially on CRM usage information 208 and/or social network service usage information 210 describing how the user interacted with one or more entities in the CRM system 102 and/or social network service 120.

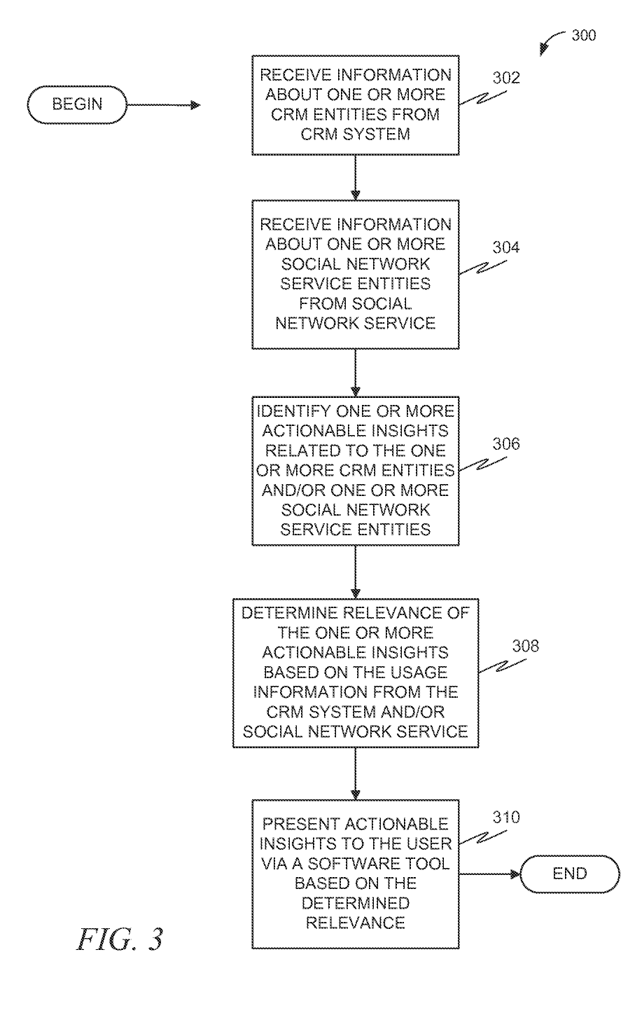

FIG. 3 is a flow diagram illustrating a method 300 of presenting actionable insights to a user in accordance with an example embodiment. An actionable insight is a piece of information that can be acted upon by the user, and maybe contain an actor, a verb, and a target. At operation 302, information about one or more Customer Relationship Management (CRM) entities is received from a CRM system, the information including an identification of each of the one or more CRM entities and usage information about how a user interacted with each of the one or more CRM entities. At operation 304, information about one or more social network entities is received from a social network system, the information including an identification of each of the one or more social network entities and usage information about how the user interacted with each of the social network entities. At operation 306, one or more actionable insights related to the one or more CRM entities and/or one or more social network service entities are identified. At operation 308, the relevance of the one or more actionable insights to the user is determined based on the usage information from the CRM system and/or the social network system. At operation 310, the one or more actionable insights are presented to the user base on the determined relevance, via a software tool.

It should be noted that the above method is only one example embodiment. In another example embodiment, only one of the CRM system and social network service are used to retrieve entities, while the other of the CRM system and social network service could still be used to obtain usage information. For example, the software tool could import CRM entities from the CRM system, but utilize usage information from the social network service regarding those CRM entities in determining the relevance of insights, even if those entities were never imported from the social network service.

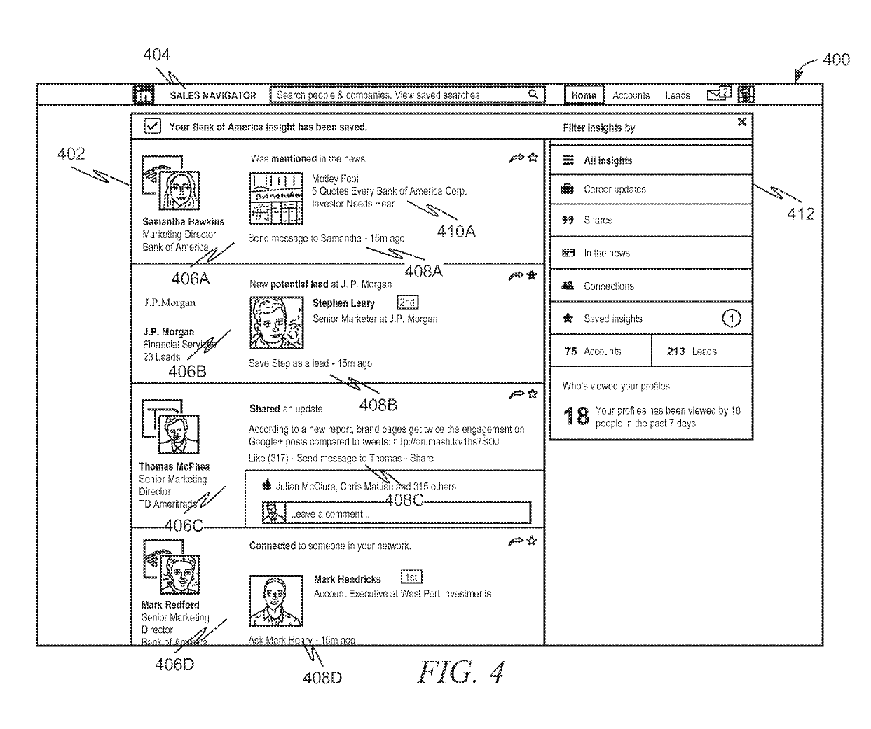

FIG. 4 is a screen capture 400 illustrating an insight teed in accordance with an example embodiment. Here, the feed 402 is presented within a tool 404 (labeled “sales navigator”). The feed 402 includes a number of different insights 406A, 406B, 406C, 406D. While optional, each of the insights 406A, 406B, 406C, 406D is presented here with a possible action 408A, 408B, 408C, 408D that the user can take with respect to the action. For example, insight .406A describes how a contact was mentioned in the news, and a snippet 410A of the article is presented. The possible action 408A the user can take here is to send a message to the contact (perhaps to congratulate her about the article).

A filtering window 412 is also provided to allow the user to directly filter the insights, instead of merely relying on the tool's 404 own filtering and selection mechanism.

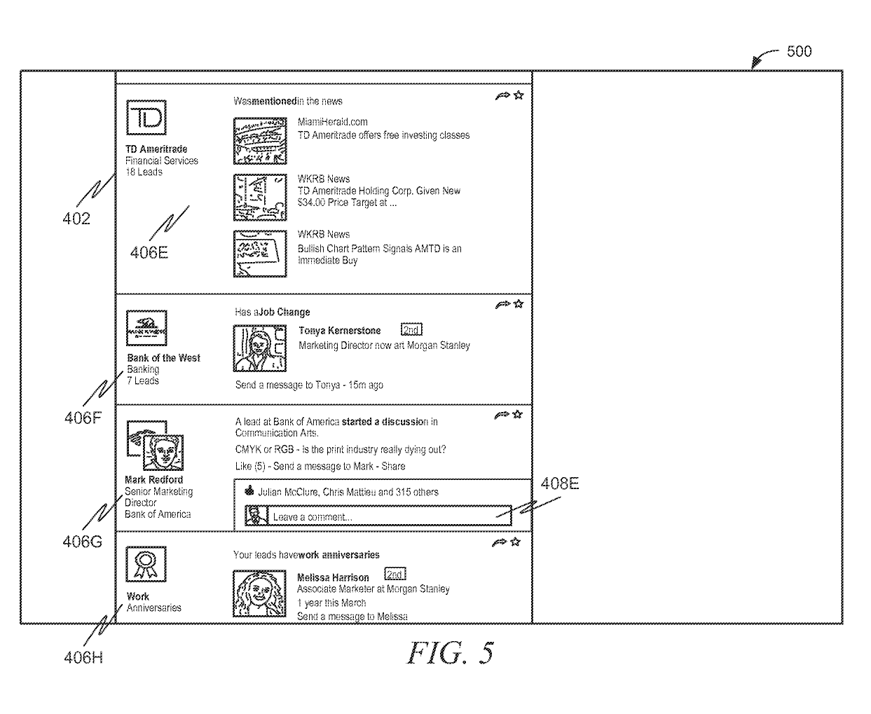

FIG. 5 is a screen capture 500 illustrating an insight feed in accordance with another example embodiment. This screen capture 500 represents the tool 404 of FIG. 4 if the user scrolls down the feed 402 more, thus revealing more insights 406E, 406F, 406G, 406H. Here, notably, insight 406E is not presented with a possible action, although the user can elect to take an action of his or her own based on this insight 406E. Additionally, insight 406G is presented with a possible action 408E that allows the user to enter text rather than merely select a link.

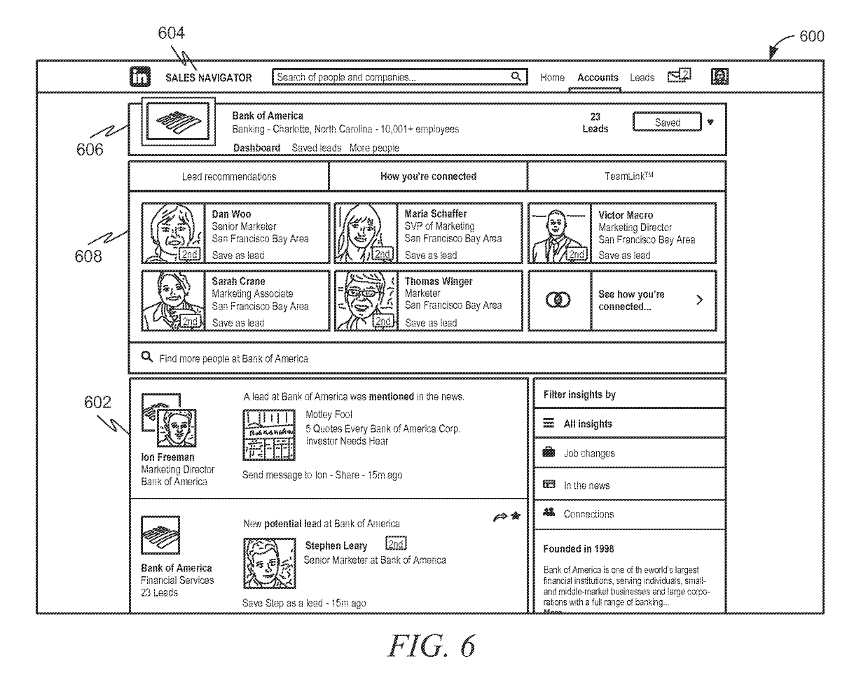

FIG. 6 is a screen capture 600 illustrating an insight feed in accordance with another example embodiment. Here, the screen capture 600 depicts an insight feed 602 being presented in a different tool 604 than the tool 404 of FIGS. 4 and 5 (here labeled “sales connect”). The feed 602 itself is presented in a similar manner to the feed 402 of FIGS. 4 and 5, although the tool 604 allows for additional windows 606, 608 allowing for further information on leads and accounts.

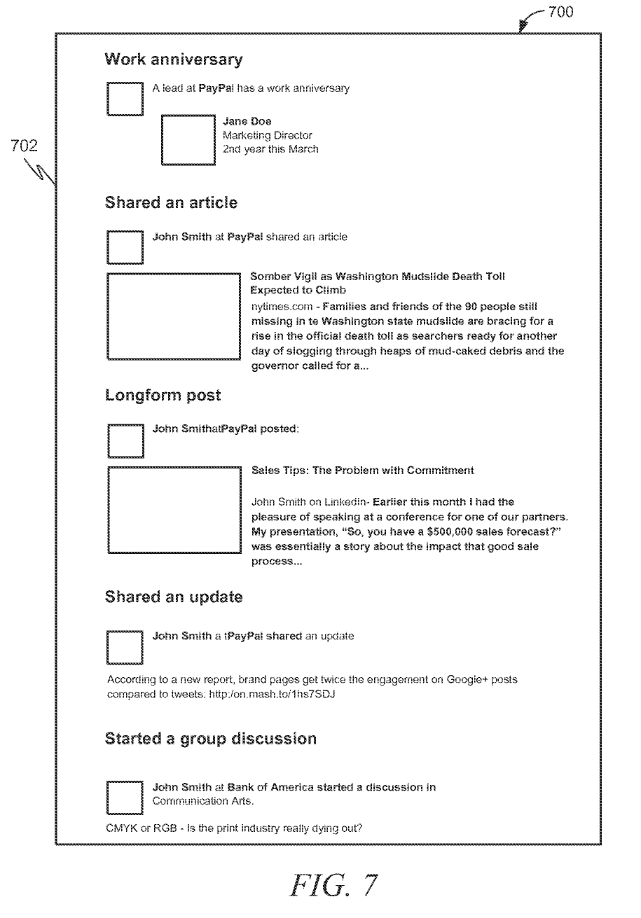

FIG. 7 is a screen capture 700 illustrating an insight feed in accordance with another example embodiment. Here, the screen capture 700 depicts an insight feed 702 presented in an email message.

### Example Mobile Device

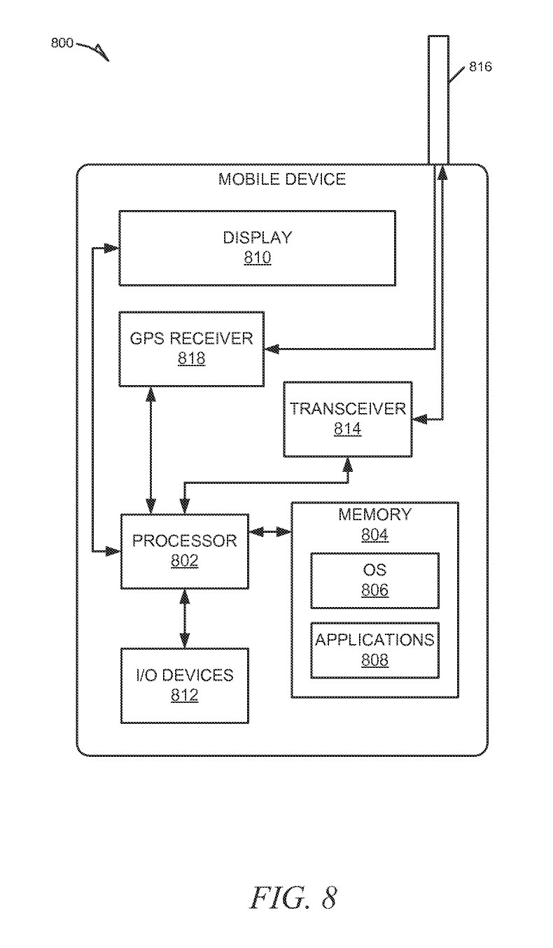

FIG. 8 is a block diagram illustrating a mobile device 800, according to an example embodiment. The mobile device 800 can include a processor 802. The processor 802 can be any of a variety of different types of commercially available processors 802 suitable for mobile devices 800 (for example, an XScale architecture microprocessor, a microprocessor without interlocked pipeline stages (MIPS) architecture processor, or another type of processor 802). A memory 804, such as a random access memory (RAM), a flash memory, or other type of memory, is typically accessible to the processor 802. The memory 804 can be adapted to store an operating system (OS) 806, as well as application programs 808. The processor 802 can be coupled, either directly or via appropriate intermediary hardware, to a display 810 and to one or more input/output (I/O) devices 812, such as a keypad, a touch panel sensor, a microphone, and the like. Similarly, in some embodiments, the processor 802 can be coupled to a transceiver 814 that interfaces with an antenna 816. The transceiver 814 can be configured to both transmit and receive cellular network signals, wireless data signals, or other types of signals via the antenna 816, depending on the nature of the mobile device 800. Further, in some configurations, a GPS receiver 818 can also make use of the antenna 816 to receive GPS signals.

### Modules, Components and Logic

Certain embodiments are described herein as including logic or a number of components, modules, or mechanisms. Modules can constitute either software modules (e.g., code embodied (1) on a non-transitory machine-readable medium or (2) in a transmission signal) or hardware-implemented modules. A hardware-implemented module is a tangible unit capable of performing certain operations and can be configured or arranged in a certain manner. In example embodiments, one or more computer systems (e.g., a standalone, client or server computer system) or one or more processors 802 can be configured by software (e.g., an application or application portion) as a hardware-implemented module that operates to perform certain operations as described herein.

In various embodiments, a hardware-implemented module can be implemented mechanically or electronically. For example, a hardware-implemented module can comprise dedicated circuitry or logic that is permanently configured (e.g., as a special-purpose processor, such as a field programmable gate array (FPGA) or an application-specific integrated circuit (ASIC)) to perform certain operations. A hardware-implemented module can also comprise programmable logic or circuitry (e.g., as encompassed within a general-purpose processor 802 or other programmable processor 802) that is temporarily configured by software to perform certain operations. It will be appreciated that the decision to implement hardware-implemented module mechanically, in dedicated and permanently configured circuitry, or in temporarily configured circuitry (e.g., configured by software) can be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor 802 configured using software, the general-purpose processor 802 can be configured as respective different hardware-implemented modules at different times. Software can accordingly configure a processor 802, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules can be regarded as being communicatively coupled. Where multiple of such hardware-implemented modules exist contemporaneously, communications can be achieved through signal transmission (e.g., over appropriate circuits and buses that connect the hardware-implemented modules). In embodiments in which multiple hardware-implemented modules are configured or instantiated at different times, communications between such hardware-implemented modules can be achieved, for example, through the storage and retrieval of information in memory structures to which the multiple hardware-implemented modules have access. For example, one hardware-implemented module can perform an operation, and store the output of that operation in a memory device to which it is communicatively coupled. A further hardware-implemented module can then, at a later time, access the memory device to retrieve and process the stored output. Hardware-implemented modules can also initiate communications with input or output devices, and can operate on a resource (e.g., a collection of information).

The various operations of example methods described herein can be performed, at least partially, by one or more processors 802 that are temporarily configured (e.g., by software) or permanently configured to perform the relevant operations. Whether temporarily or permanently configured, such processors 802 can constitute processor-implemented modules that operate to perform one or more operations or functions. The modules referred to herein can, in some example embodiments, comprise processor-implemented modules.

Similarly, the methods described herein can be at least partially processor-implemented. For example, at least some of the operations of a method can be performed by one or more processors 802 or processor-implemented modules. The performance of certain of the operations can be distributed among the one or more processors 802, not only residing within a single machine, but deployed across a number of machines. In some example embodiments, the processor 802 or processors 802 can be located in a single location (e.g., within a home environment, an office environment or as a server farm), while in other embodiments the processors 802 can be distributed across a number of locations.

The one or more processors 802 can also operate to support performance of the relevant operations in a “cloud computing” environment or as a “software as a service” (SaaS). For example, at least some of the operations can be performed by a group of computers (as examples of machines including processors 802), these operations being accessible via a network (e.g., the Internet) and via one or more appropriate interfaces (e.g., application program interfaces (APIs).)

### Electronic Apparatus and System

Example embodiments can be implemented in digital electronic circuitry, or in computer hardware, firmware, software, or in combinations of them. Example embodiments can be implemented using a computer program product, e.g., a computer program tangibly embodied in an information carrier, e.g., in a machine-readable medium for execution by, or to control the operation of data processing apparatus, e.g., a programmable processor 802, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network,

In example embodiments, operations can be performed by one or more programmable processors 802 executing a computer program to perform functions by operating on input data and generating output. Method operations can also be performed by, and apparatus of example embodiments can be implemented as, special purpose logic circuitry, e.g., a FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor 802), or a combination of permanently and temporarily configured hardware can be a design choice. Below are set out hardware (e.g., machine) and software architectures that can be deployed, in various example embodiments.

### Example Machine Architecture and Machine-Readable Medium

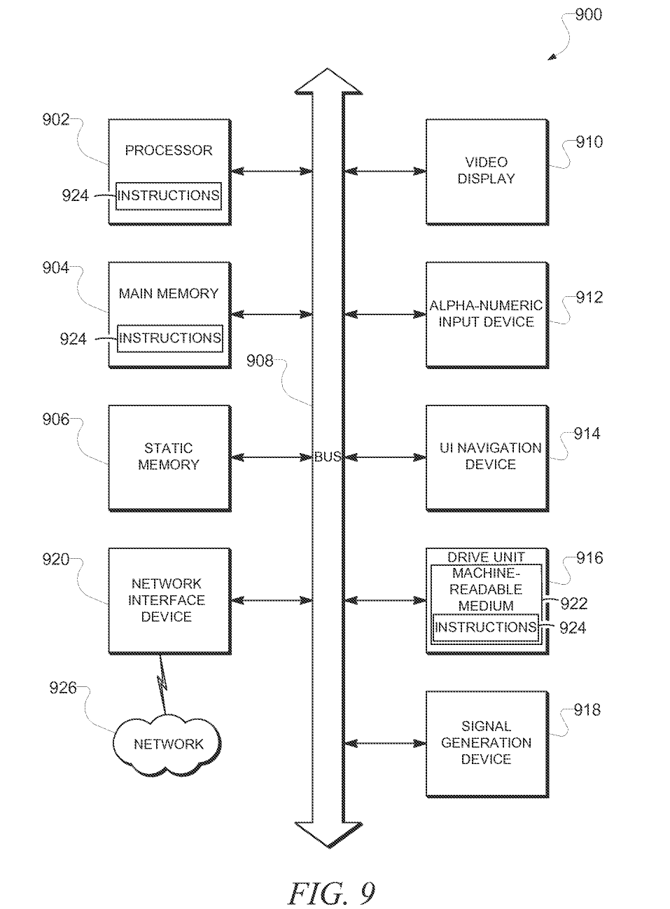

FIG. 9 is a block diagram of machine in the example form of a computer system 900 within which instructions, for causing the machine to perform any one or more of the methodologies discussed herein, can be executed. In alternative embodiments, the machine operates as a standalone device or can be connected (e.g., networked) to other machines. In a networked deployment, the machine can operate in the capacity of a server or a client machine in server-client network environment, or as a peer machine in a peer-to-peer (or distributed) network environment. The machine can be a personal computer (PC), a tablet PC, a set-top box (STB), a personal digital assistant (PDA), a cellular telephone, a web appliance, a network. router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a CPU, a graphics processing unit (GPU), or both), a main memory 904 and a static memory 906, which communicate with each other via a bus 908. The computer system 900 can further include a video display unit 910 (e.g., a liquid crystal display (LCD) or a cathode ray tube (CRT)). The computer system 900 also includes an alphanumeric input device 912 (e.g., a keyboard or a touch-sensitive display screen), a user interface (UI) navigation device 914 (e.g., a mouse), a disk drive unit 916, a signal generation device 918 (e.g., a speaker), and a network interface device 920.

### Machine-Readable Medium

The disk drive unit 916 includes a machine-readable medium 922 on which is stored one or more sets of instructions and data structures (e.g., software) 924 embodying or utilized by any one or more of the methodologies or functions described herein. The instructions 924 can also reside, completely or at least partially, within the main memory 904 and/or within the processor 902 during execution thereof by the computer system 900, the main memory 904 and the processor 902 also constituting machine-readable media 922.

While the machine-readable medium 922 is shown in an example embodiment to be a single medium, the term “machine-readable medium” can include a single medium or multiple media (e.g., a centralized or distributed database, and/or associated caches and servers) that store the one or more instructions 924 or data structures. The term “machine-readable medium” shall also be taken to include any tangible medium that is capable of storing, encoding or carrying instructions 924 for execution by the machine and that cause the machine to perform any one or more of the methodologies of the present disclosure or that is capable of storing, encoding or carrying data structures utilized by or associated with such instructions 924. The term “machine-readable medium” shall accordingly be taken to include, but not be limited to, solid-state memories, and optical and magnetic media. Specific examples of machine-readable media 922 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

### Transmission Medium

The instructions 924 can further be transmitted or received over a communications network 926 using a transmission medium. The instructions 924 can be transmitted using the network interface device 920 and any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding or carrying instructions 924 for execution by the machine, and includes digital or analog communications signals or other intangible media to facilitate communication of such software.

Although an embodiment has been described with reference to specific example embodiments, it will be evident that various modifications and changes can be made to these embodiments without departing from the broader spirit and scope of the disclosure. Accordingly, the specification and drawings are to be regarded in an illustrative rather than a restrictive sense. The accompanying drawings that form a part hereof, show by way of illustration, and not of limitation, specific embodiments in which the subject matter can be practiced. The embodiments illustrated are described in sufficient detail to enable those skilled in the art to practice the teachings disclosed herein. Other embodiments can be utilized and derived therefrom, such that structural and logical substitutions and changes can be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter can be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose can be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A computer-implemented method comprising:
receiving relationship-based information about one or more Customer Relationship Management (CRM) entities from a CRM system, the CRM system being a specialized computer system designed to organize, automate, and synchronize sales information in a CRM data store via a master data management layer, each CRM entity being a business contact of a user, the relationship-based information including an identification of each of the one or more CRM entities and usage information about communications made between the user and each of the one or more CRM entities via the CRM system;
identifying, at a software tool distinct from the CRM system, one or more actionable insights related to the one or more CRM entities, the one or more actionable insights obtained via a federator in an insight module, the one or more actionable insights each describing information about an event pertaining to a corresponding one of the CRM entities, the federator receiving the one or more actionable insights from an insight gatherer that receives streams of actor/verb/object data structures from a plurality of sources, the identifying including the federator searching the actor/verb/object data structures to find one or more actor/verb/object data structures having an actor or object matching the corresponding one of the CRM entities;
determining relevance of the one or more actionable insights to the user based on the usage information; and
presenting one or more of the one or more actionable insights to the user based on the determined relevance via the software tool.

2. The method of claim 1, further comprising:
receiving information about one or more social network entities from a social network system, the information including an identification of each of the one or more social network entities and usage information about how the user interacted with each of the social network entities;
identifying, at the software tool, one or more actionable insights related to the social network entities;
determining relevance of the one or more actionable insights related to the social network entities based on the usage information about how the user interacted with each of the social network entities: and
presenting one or more of the actionable insights related to the social network entities to the user based on the determined relevance of the one or more actionable insights related to the social network entities via the software tool.

3. The method of claim 1, wherein the presenting includes presenting the one or more of the one or more actionable insights based on reverse chronological order as to a timestamp for each actionable insight.

4. The method of claim 1, wherein the presenting includes filtering the one or more actionable insights by comparing a relevance score computed for each actionable insight to a threshold and not displaying actionable insights with relevance scores below the threshold.

5. The method of claim 4, wherein the filtering includes applying weights to the relevance scores based on diversity of actionable insight type.

6. The method of claim 4, wherein the filtering includes applying weights to the relevance scores based on activeness of the user.

7. The method of claim 1, wherein the determining relevance is further based on usage information from a social network service involving how the user interacts with the one or more CRM entities on the social network service.

8. A system comprising:
one or more processors;
a federator executable by the one or more processors and configured to receive relationship-based information about one or more Customer Relationship Management (CRM) entities from a CRM system, the CRM system being a specialized computer system designed to organize, automate, and synchronize sales information in a CRM data store via a master data management layer, each CRM entity being a business contact of a user, the relationship based information including an identification of each of the one or more CRM entities and usage information about communications made between the user and each of the one or more CRM entities via the CRM system;
an insight gatherer configured to identify one or more actionable insights related to the one or more CRM entities, the one or more actionable insights obtained via a federator in an insight module, the one or more actionable insights each describing information about an event pertaining to a corresponding one of the CRM entities, the insight gatherer receiving streams of actor/verb/object data structures from a plurality of sources, the identifying including the federator searching the actor/verb/object data structures to find one or more actor/verb/object data structures having an actor or object matching the corresponding one of the CRM entities; and
the federator further configured to determine relevance of the one or more actionable insights to the user based on the usage information and present one or more of the one or more actionable insights to the user based on the determined relevance.

9. The system of claim 8, wherein the federator and insight gatherer are located in a tool separate and distinct from the CRM system.

10. The system of claim 8, wherein the federator is further configured to receive information about one or more social network entities from a social network system, the information including an identification of each of the one or more social network entities and usage information about how the user interacted with each of the social network entities; and
the insight gatherer is further configured to identify one or more actionable insights related to the social network entities; and
the federator is further configured to determine relevance of the one or more actionable insights related to the social network entities based on the usage information about how the user interacted with each of the social network entities and present one or more of the actionable insights related to the social network entities to the user based on the determined relevance of the one or more actionable insights related to the social network entities via the software tool.

11. The system of claim 8, wherein the presenting includes presenting the one or more of the one or more actionable insights based on reverse chronological order as to a timestamp for each actionable insight.

12. The system of claim 8, wherein the presenting includes filtering the one or more actionable insights by comparing a relevance score computed for each actionable insight to a threshold and not displaying actionable insights with relevance scores below the threshold.

13. The system of claim 12, wherein the filtering includes applying weights to the relevance scores based on diversity of actionable insight type.

14. The system of claim 12, wherein the filtering includes applying weights to the relevance scores based on activeness of the user.

15. The system of claim 8, wherein the determining relevance is further based on usage information from a social network service involving how the user interacts with the one or more CRM entities on the social network service.

16. A non-transitory machine-readable storage medium having instruction data to cause a machine to perform the following operations:
receiving relationship-based information about one or more Customer Relationship Management (CRM) entities from a CRM system, the CRM system being a specialized computer system designed to organize, automate, and synchronize sales information in a CRM data store via a master data management layer, each CRM entity being a business contact of a user, the relationship-based information including an identification of each of the one or more CRM entities and usage information about communications made between the user and each of the one or more CRM entities via the CRM system;
identifying, at a software tool distinct from the CRM system, one or more actionable insights related to the one or more CRM entities, the one or more actionable insights obtained via a federator in an insight module, the one or more actionable insights each describing information about an event pertaining to a corresponding one of the CRM entities, the federator receiving the one or more actionable insights from an insight gatherer that receives streams of actor/verb/object data structures from a plurality of sources, the identifying including the federator searching the actor/verb/object data structures to find one or more actor/verb/object data structures having an actor or object matching the corresponding one of the CRM entities;
determining relevance of the one or more actionable insights to the user based on the usage information; and
presenting one or more of the one or more actionable insights to the user based on the determined relevance via the software tool.

17. The non-transitory machine-readable storage medium of claim 16, wherein the operations further comprise:
receiving information about one or more social network entities from a social network system, the information including an identification of each of the one or more social network entities and usage information about how the user interacted with each of the social network entities:
identifying, at the software tool, one or more actionable insights related to the social network entities;
determining relevance of the one or more actionable insights related to the social network entities based on the usage information about how the user interacted with each of the social network entities; and
presenting one or more of the actionable insights related to the social network entities to the user based on the determined relevance of the one or more actionable insights related to the social network entities via the software tool.

18. The non-transitory machine-readable storage medium of claim 17, wherein the presenting includes presenting the one or more of the one or more actionable insights based on reverse chronological order as to a timestamp for each actionable insight.

19. The non-transitory machine-readable storage medium of claim 17, wherein the presenting includes filtering the one or more actionable insights by comparing a relevance score computed for each actionable insight to a threshold and not displaying actionable insights with relevance scores below the threshold.

20. The non-transitory machine-readable storage medium of claim 19, wherein the filtering includes applying weights to the relevance scores based on diversity of actionable insight type.
